(19) United States
(12) Patent Application Publication
(10) Pub. No.: US 2012/0096285 A1
(43) Pub. Date: Apr. 19, 2012

(54) Power Management Method and Portable Electronic Device Using the Same

(76) Inventor: Hsueh-Teng Liu, New Taipei City (TW)

(21) Appl. No.: 13/118,597

(22) Filed: May 31, 2011

(30) Foreign Application Priority Data
Oct. 19, 2010 (TW) 099135579

(51) Int. Cl. G06F 1/26

(52) U.S. Cl. 713/300

(57) ABSTRACT

A power management method for a portable electronic device having a battery providing operating power includes receiving a command utilized for indicating the portable electronic device to execute a function, determining electricity required by executing the function and electricity stored in the battery, comparing the electricity required by executing the function and the electricity stored in the battery, and generating an indication signal when the electricity required by executing the function is greater than the electricity stored in the battery.

### BACKGROUND OF THE INVENTION

1. Field of the Invention

The present invention relates to a power management method and portable electronic device using the same, and more particularly, to a power management method and portable electronic device capable of preventing displeasure or discouragement of use caused by an abrupt interruption due to a power shortage, so as to enhance utilization convenience.

2. Description of the Prior Art

Due to technology advancement and industry development, portable multimedia players are frequently used in daily lives. In order to facilitate the portability, a portable electronic device is equipped with a battery for storing electricity, so as to provide operating power. However, the electricity stored in the battery is limited. If the electricity runs out during playback of a multimedia file, the playback is interrupted, which discourages a user from using. In such a situation, the prior art has disclosed an indicating mechanism for sending a message indicating that the battery is running out. However, the indicating mechanism still interrupts the playback.

Therefore, when the battery of the portable multimedia player is out of electricity, playback of a multimedia file is interrupted, which might bring displease to a user, and discourage the user from using.

### SUMMARY OF THE INVENTION

Therefore, the present invention mainly provides a power management method and portable electronic device using the same.

The present invention discloses a power management method for a portable electronic device having a battery providing operating power. The power management method includes the steps of receiving a command utilized for indicating the portable electronic device to execute a function; determining electricity required by executing the function and electricity stored in the battery; comparing the electricity required by executing the function and the electricity stored in the battery; and generating an indication signal when electricity required by executing the function is greater than the electricity stored in the battery.

The present invention further discloses a portable electronic device. The portable electronic device includes a battery, for providing operating power; a central processing unit; a memory, for storing a program code, which indicates the central processing unit to execute the following steps receiving a command utilized for indicating the portable electronic device to execute a function; determining electricity required by executing the function and electricity stored in the battery; comparing the electricity required by executing the function and the electricity stored in the battery; and generating an indication signal when the electricity required by executing the function is greater than the electricity stored in the battery.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a power management process according to an embodiment of the present invention.

FIG. 2 is a schematic diagram of an implemented structure of the power management process in FIG. 1.

### DETAILED DESCRIPTION

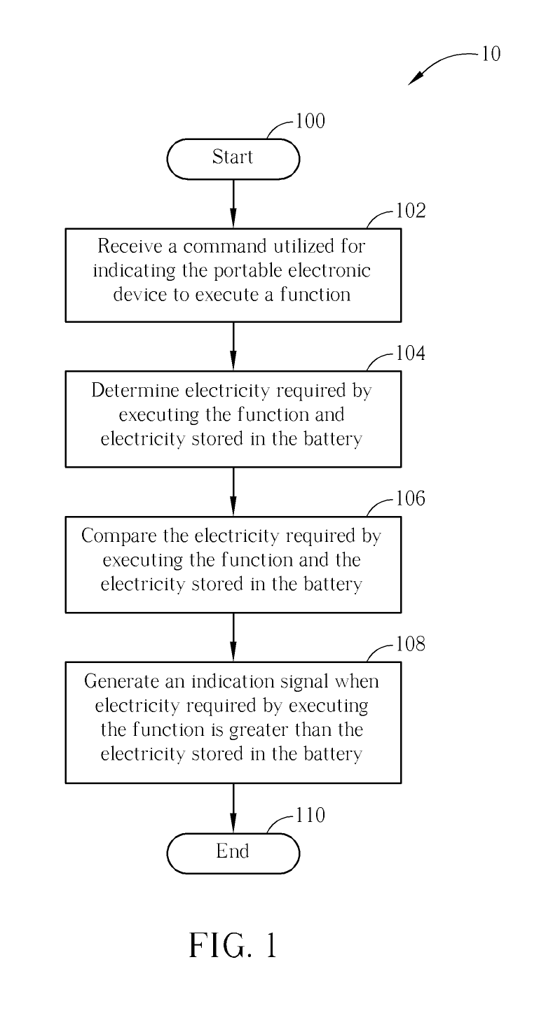

Please refer to FIG. 1, which is a schematic diagram of a power management process 10 according to an embodiment of the present invention. The power management process 10 is utilized for a portable electronic device using a battery for providing operating power. The power management process 10 includes the following steps:

Steps 100: Start.

Steps 102: Receive a command utilized for indicating the portable electronic device to execute a function.

Steps 104: Determine electricity required by executing the function and electricity stored in the battery.

Steps 106: Compare the electricity required by executing the function and the electricity stored in the battery.

Steps 108: Generate an indication signal when electricity required by executing the function is greater than the electricity stored in the battery.

Steps 110: End.

In short, when a user intends to execute a function on the portable electronic device, the power management process 10 of the present invention determines electricity required by executing the function and electricity stored in the battery, and compares them. If the electricity required by executing the function is greater than the electricity stored in the battery, the power management process 10 indicates the portable electronic device to generate a corresponding indication signal, in order to indicate the user the electricity stored in the battery is not sufficient to fully execute the function, such that the user can be prepared if any interruption comes up upon executing the function.

Therefore, when the electricity stored in the battery of the portable electronic device is not sufficient to fully execute the function, the power management process 10 informs such a situation via the indication signal, such that the user is prepared, to prevent displeasure caused by abrupt interruption of executing the function or discouraging the user from using. Note that, the power management process 10 is a preferred embodiment of the present invention, and those skilled in the art should readily make modifications according to different system requirements.

For example, if the power management process 10 is applied on a portable multimedia player, when the user intends to play at least one multimedia files, the power management process 10 determines whether electricity stored in a battery of the portable multimedia player is sufficient to play out the multimedia files. If the electricity stored in the battery is not sufficient to play out the multimedia files, the power management process 10 indicates the portable multimedia player to output a corresponding indication signal. The indication signal is not limited in specific formats, and can be a sound signal, image signal, etc., and should be adjusted according to output methods supported by the portable electronic device. Furthermore, in step 104, methods of determining the electricity required by executing the function is well-known in the industry, and can be adjusted according to different applications. For example, if a music file is to be played, electricity required by playing the music file can be determined by volume, acoustics, playback time of the music file, whether an earphone is used, etc. By the same token, if a video file is to be played, electricity required by playing the video file can be determined by luminance, contrast, image quality, resolutions, playback time of the video file, etc.

On the other hand, when the electricity stored in the battery is not sufficient to execute a certain function, the power management process 10 can further provide alternative execution plans, such that the portable electronic device uses electricity lower than the electricity stored in the battery to execute the function. Take playing a plurality of multimedia files for example, when the power management process 10 determines the electricity stored in the battery is not sufficient to play out all the multimedia files, except for generating the corresponding indication signal, an embodiment of the present invention can further provide alternative execution plans for the user to choose from. For instance,

Plan A: Indicate the user to reduce the multimedia files to an amount that the electricity stored in the battery can afford;

Plan B: Lower powers, such as monitor brightness, contrast, volumes, etc.;

Plan C: Lower playback quality, such as image quality, resolutions, acoustics, etc.

The three alternative execution plans are examples to elaborate that when the electricity stored in the battery is not sufficient to play out the multimedia files selected by the user, the power management process 10 can further provide the alternative execution plans, such that the related portable multimedia player can partially play the multimedia files, or play out all the multimedia files with lower power consumption. Therefore, those skilled in the art should readily develop alternative execution plans according to system requirements. For instance, when the user selects the multimedia files, the portable multimedia player can dynamically indicate that whether the electricity stored in the battery is sufficient to play out the selected multimedia files.

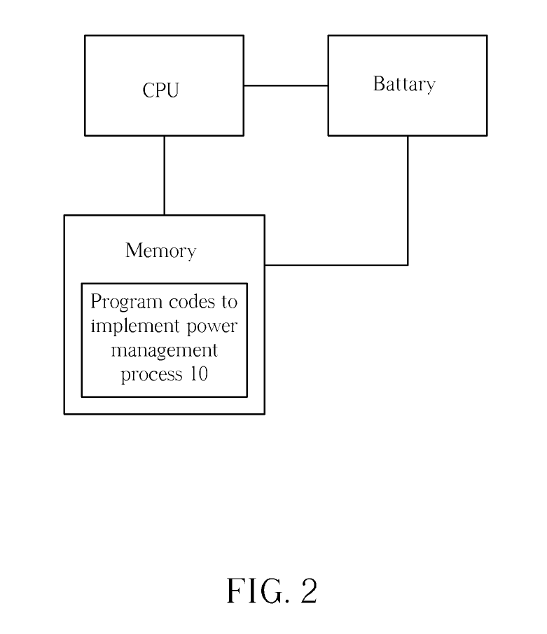

In addition, implementation of the power management process 10 should be well-known to those skilled in the art. For example, each step of the power management process 10 can be compiled into a program code as a unit with commands, parameters, or variables of a specific programming language, and stored in a memory, to indicate a central processing unit of the related portable electronic device to execute each step of the power management process 10. A simplified related structure is illustrated in FIG. 2.

In the prior art, when the electricity of the portable multimedia player runs out, the playback is interrupted, which might bring displeasure to the user, and discourage the user from using. In comparison, the present invention determines whether the electricity stored in the battery is sufficient when the portable electronic device executes a function, and informs the user of the determination result, such that the user can be prepared, in order to prevent the displeasure caused by an abrupt interruption.

To sum up, when the electricity stored in the battery of the portable electronic device is not sufficient to fully execute the requested function, the present invention notifies the related situation via an indication signal, and can further provide alternative execution plans with lower power consumption. Consequently, the user can be prepared, so as to prevent displeasure caused by abrupt interruption or discouraging the user from using, as well as enhance utilization convenience.

Those skilled in the art will readily observe that numerous modifications and alterations of the device and method may be made while retaining the teachings of the invention.

What is claimed is:

1. A power management method for a portable electronic device having a battery providing operating power, the power management method comprising:
receiving a command utilized for indicating the portable electronic device to execute a function;
determining electricity required by executing the function and electricity stored in the battery;
comparing the electricity required by executing the function and the electricity stored in the battery; and
generating an indication signal when electricity required by executing the function is greater than the electricity stored in the battery.

2. The power management method of claim 1, wherein the function is playing at least one multimedia file.

3. The power management method of claim 2, wherein the step of determining the electricity required by executing the function is in accordance with a playback time of the at least one multimedia file.

4. The power management method of claim 1, wherein the indication signal is a sound or an image signal.

5. The power management method of claim 1, further comprising providing at least one alternative execution plan when the electricity required by executing the function is greater than the electricity stored in the battery, as the result that the portable electronic device uses electricity lower than the electricity stored in the battery to execute the function.

6. A portable electronic device, comprising:
a battery, for providing operating power;
a central processing unit;
a memory, for storing a program code, which indicates the central processing unit to execute the following steps:
receiving a command utilized for indicating the portable electronic device to execute a function;
determining electricity required by executing the function and electricity stored in the battery;
comparing the electricity required by executing the function and the electricity stored in the battery; and
generating an indication signal when the electricity required by executing the function is greater than the electricity stored in the battery.

7. The portable electronic device of claim 6, wherein the function is playing at least one multimedia file.

8. The portable electronic device of claim 7, wherein the step of determining electricity required by executing the function is in accordance with a playback time of the at least one multimedia file.

9. The portable electronic device of claim 6, wherein the indication signal is a sound or an image signal.

10. The portable electronic device of claim 6, wherein the program code further indicates the central processing unit to provide at least one alternative execution plan when the electricity required by executing the function is greater than the electricity stored in the battery, as the result that the portable electronic device uses electricity lower than the electricity stored in the battery to execute the function.
